(19) United States
(12) Patent Application Publication
(10) Pub. No.: US 2005/0103628 A1
(43) Pub. Date: May 19, 2005

(54) Apparatus for concurrent electrophoresis in a plurality of gels

(76) Inventors: Thomas R. Jackson, La Jolla, CA (US); Adam S. Henry, Oceanside, CA (US); Joseph W. Amshey, Encinitas, CA (US); Roumen A. Bogoev, San Marcos, CA (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/948,453

(22) Filed: Sep. 22, 2004

Related U.S. Application Data
(60) Provisional application No. 60/505,051, filed on Sep. 22, 2003.

(51) Int. Cl. G01N 27/453

(52) U.S. Cl. 204/456; 204/606

(57) ABSTRACT

Apparatus and methods for conducting electrophoretic separation concurrently in a plurality of gels with improved reproducibility among the gels.

### CROSS-REFERENCE TO RELATED APPLICATION

This application claims the benefit of U.S. provisional patent application Ser. No. 60/505,051, filed Sep. 22, 2003, the disclosure of which is incorporated herein by reference in its entirety.

### FIELD OF THE INVENTION

The present invention relates to apparatus and methods for conducting electrophoretic separation concurrently in a plurality of gels. More specifically, the present invention relates to apparatus and methods for performing multiple concurrent electrophoresis experiments with increased reproducibility among the gels through incorporation in the apparatus of improved passive thermal management features and improved electric field geometries.

### BACKGROUND OF THE INVENTION

Gel electrophoresis is a common procedure for the separation of biological molecules, such as DNA, RNA, and proteins. In gel electrophoresis, the molecules are separated into bands according to the rate at which an imposed electric field causes them to migrate through a filtering gel.

The basic apparatus used in this technique consists of a gel enclosed in a glass tube or sandwiched as a slab between glass or plastic plates. The gel has an open molecular network structure, defining pores which are saturated with an electrically conductive buffered solution of salt. These pores through the gel are large enough to admit passage of the migrating molecules.

The gel is placed in contact with buffer solutions that make electrical contact between the gel and the cathode and anode of an electrical power supply. A sample containing the macromolecules and a tracking dye is placed on top of the gel. An electric potential is applied to the gel causing the sample macromolecules and tracking dye to migrate toward the bottom of the gel. The locations of the bands of separated macromolecules then are determined. By comparing the distance moved by particular bands in comparison to the tracking dye and macromolecules of known mobility, the mobility of sample macromolecules can be determined. Once the mobility of the sample macromolecules is determined, the size of the macromolecule can be calculated.

As electrophoresis is used with increasing frequency in basic research, quality control, and in forensic and clinical diagnoses, it is increasingly important to be able to replicate all experimental conditions in multiple locations and labs.

Among these experimental conditions, temperature is extremely important.

The application of an electrical field to a gel results in the generation of heat. In general, higher temperatures increase the molecular kinetics, which results in faster migration of macromolecules through the separating gel. Further, a temperature increase affects the electrical conductivity of an electrolyte solution and may cause dissociation.

Without temperature control or uniform electric field geometry, gels often exhibit uneven temperatures across the width of the gel resulting in “smile” or “frown” distortions. Smile distortions occur when bands migrate faster on the sides than in the middle of the gel; frown distortions occur when bands migrate faster in the middle than on the sides.

Often, even a small temperature differential between the front and rear plates of the gel, if not mitigated, can cause the resulting bands to slant front to back, depending on the thickness of the gel and the heat transfer properties of the cassette plates. This challenge is particularly acute in test runs where the molecular migration rates exhibit overly temperature sensitive characteristics, as in DNA sequencing. For such runs, even a slight temperature differential, e.g. of 0.1° C., can cause the slanted bands to appear overlapping.

Additionally, overheating of the gel (e.g., greater than 70° C.) can result in deleterious effects such as breakdown of the gel matrix resulting in poor resolution and band shape, alteration of the macromolecules including denaturation, alkylation or oxidation, and/or damage to the electrophoresis apparatus itself.

In DNA sequencing, electrophoresis is conducted at high voltage (1200-3000 volts, 55 watts) to maintain a gel temperature of 45°-50° C. for maximum resolution of the denatured DNA strands. The temperature is controlled by the amount of power applied to the gel. Gels that run too cool (e.g., <40° C.) will have bands that are blurred, perhaps due to incomplete denaturation. Gels that run too warm (e.g., >60° C.) will lose resolution, perhaps due to the breakdown of the polyacrylamide.

Precise temperature control is particularly critical in Single Stranded Conformational polymorphism (SSCP) analysis of DNA, where bands are extremely close together. The relative temperature differential between the front and the back surfaces of the gel therefore can have a critical effect on the resolution of the DNA bands.

Various means have been used to attempt to control the temperature of the gel during electrophoresis. These include applying active or passive heat sinks to one side of the gel, regulating power to the gel, employing an enclosed heat exchanger internal to one of the buffer chambers, immersing the gels in a buffer-filled tank containing a heater/circulator, circulating the buffer through tubing immersed in an ice water bath, circulating the buffer through an external metal heat exchanger, and use of piezo thermo-electric heater/cooler controls.

These means are limited in their ability to provide a compact apparatus for maintaining consistent and uniform thermal control across the area encompassing the front and back of the electrophoresis gels. The heat sinks exchange heat on only one side of the gel; the regulation of power to the gels cannot control regional hot spots and obviously limits the application of high wattage to the gels; the internal heat exchanger again exchanges heat on only one side of the gel and does not actively circulate buffer, resulting in vertical thermal gradients within the buffer chamber; immersing the gels in a heater tank is cumbersome, in that it requires a large volume of buffer and cannot cool the gels; and circulating the buffer through tubing immersed in an ice water bath is also cumbersome, and makes difficult fine control of temperature.

Circulating the buffer through an external metal heat exchanger provides the most satisfactory temperature control. However, with the current electrophoresis systems, two pumps and heat exchangers would be required to assure uniformity of temperature and separation of the buffer fluids between the cathode and anode chambers. Further, with current electrophoresis systems, circulation of buffer within the chambers and across the gels is random and undirected, which may result in vertical and horizontal thermal gradients.

Moreover, for electrophoretic separation, the first and second buffer solutions must be isolated from one another. To provide isolation, prior art electrophoresis systems use various methods, among which is use of a buffer core to which the gel cassettes are secured during electrophoresis. Previously known electrophoresis systems using a buffer core commonly use a buffer core subassembly containing clamps or latches that secure the gel cassettes to the buffer core. Once the cassettes are secured, the buffer core subassembly must then be loaded in the container prior to electrophoretic separation. For example, in prior art systems that use a clamping mechanism, a user generally must first construct a clamping subassembly that is then loaded into the container prior to performing electrophoresis. It would be desirable to provide a clamping device that is easier to use and does not require additional or moving parts. For example, there would be no need to configure, assemble, or adjust a clamp or other adjustable part.

Various prior art patents have proposed apparatus and methods for simultaneously running multiple gels, but many potential problems exist, including ineffective temperature control on both sides of the gel cassettes, ineffective or inconvenient clamping of gel cassettes, and inability to apply a uniform electrical field to all of the gels.

For example, U.S. Pat. No. 6,451,193 to Fernwood et al. (Fernwood) describes a single cell configured to receive multiple slab gels for conducting simultaneous electrophoresis experiments. The multitude of slab gels are supported vertically and parallel to one another while immersed in a buffer solution. A voltage is applied to all gels simultaneously while temperature control is achieved by circulating the buffer solution upward through the cell and cooling the circulating buffer solution with a tube heat exchanger positioned on the floor of the cell.

There are several drawbacks associated with the electrophoresis system described in Fernwood, and in particular, the relative complexity of the buffer circulation and cooling mechanisms that are employed. For example, with respect to the cooling mechanism, circulation is effected by a coolant pump and chilling of the coolant prior to its return to the tank requires an external chilling or refrigeration unit. With respect to the buffer circulation mechanism, an external pump and an external circulation line are required. All of these external components make the device more cumbersome, and proper circulation of the buffer and coolant depend on proper and consistent operation of several external components.

Another drawback associated with the device described in Fernwood is that the coolant is only circulated in tubing at the bottom of the tank, which may result in inconsistent cooling of a vertically upright gel cassette. Moreover, the coolant traverses the floor of the tank four times before further chilling of the coolant occurs. Therefore, coolant properties may vary at different locations that the coolant traverses the floor of the tank.

In view of these drawbacks of previously known systems, it would be desirable to provide apparatus and methods for conducting multiple electrophoresis experiments that employ a passive cooling mechanism to avoid the need for complex, ineffective or cumbersome active cooling mechanisms.

It also would be desirable to provide apparatus and methods for conducting multiple electrophoresis experiments that uses a simple clamping mechanism, without moving parts, to secure the gel cassettes in place and provide an effective seal between anode and cathode buffer solutions.

It further would be desirable to provide apparatus and methods for conducting multiple electrophoresis experiments that employ one lower buffer chamber that is common to all gel cassettes in the container.

It still further would be desirable to provide apparatus and methods for conducting multiple electrophoresis experiments that consistently control the temperature of the electrophoresis gels, regardless of the number of gels being run at any given time, particularly while maintaining a uniform electric field across the width of the gel

### SUMMARY OF THE INVENTION

In view of the foregoing, the present invention provides an apparatus and methods for conducting multiple electrophoresis experiments that consistently control the temperature of the electrophoresis gels, regardless of the number of gels being run at any given time. This temperature control is achieved for electrophoretic separation concurrently in a plurality of gels, by using passive thermal management to avoid the need for complex, ineffective or cumbersome active cooling mechanisms.

Furthermore, the apparatus and methods for conducting electrophoretic separation of the present invention provide homogeneous electric fields across the width of a gel. The temperature and electric field control of the present invention results in dye fronts that are within 10 mm from each other, within 5 mm from each other, or within 25%, 15%, 10%, or 5% of the length of a run.

In yet another embodiment, the present invention provides an apparatus and methods for conducting electrophoretic separation concurrently in a plurality of gels using a simple clamping mechanism, without moving parts, to secure the gel cassettes in place and provide an effective seal between anode and cathode buffer solutions.

In yet another embodiment, provided herein is an apparatus and methods for conducting multiple electrophoresis experiments that employ one lower buffer chamber that is common to all gel cassettes in the container.

Accordingly, provided herein in a first embodiment, is an apparatus or a system for removably positioning one or more gel cassettes for electrophoresis, each gel cassette having a first face, a second face, and a gel disposed therebetween. The apparatus comprises a fluid-retaining container and means for apportioning the interior of the container into a plurality of volumes upon the positioning of one or more gel cassettes within the container. Each of the volumes is proportionate to the number of positioned cassette faces with which it is in fluid contact. Accordingly, the upper buffer volumes within buffer cores of the container are within 75% of each other, and lower buffer volumes per gel are within 75% of each other when the chamber has different numbers of gels, for example from 3 to 50 gels.

In one series of embodiments, the apportioning means include means that are integral to the container and at least one means that is removably engageable within the container.

In some embodiments, the apparatus further comprises means for concurrently establishing an electric field within the gel of each positioned cassette, wherein the field is substantially uniform among all of the positioned gels and substantially homogeneous across the width of each gel. Substantially uniform means that the field is within 10% among all positioned gels. In certain of these embodiments, the field establishing means include means integral to the container and at least one means removably engageable within the container. The combination of field uniformity and temperature regulation of apparatuses and methods of the present invention results in dye fronts that are within 15 mm from each other, within 10 mm from each other, within 5 mm from each other, or a traveled distance difference that is no more than 25%, 15%, 10%, 5%, 4%, 3%, or 2% of the length of a run at the end of an electrophoretic separation run. Therefore, for a 10% distance difference for a 65 mm gel length electrophoretic run, the dye fronts between different gels in the container at the end of the run are within 7 mm of each other.

In certain embodiments, each of the apportioning means and the field-establishing means includes both means that are integral to the container and means that are removably engageable therein. In particularly useful embodiments, each one of the removably engageable field establishing means is integrated into one of the at least one removably engageable apportioning means to form a buffer core body.

Typically, the apparatus is configured so that the plurality of apportioned volumes includes at least one first volume and a single second volume; the positioned cassettes render each of the at least one first volumes fluidly noncommunicating with the single second volume. In embodiments that include at least one buffer core, each of the at least one first volumes is internal to a buffer core.

In various embodiments, the integral apportioning means include, for each buffer core potentially engageable within the container, a set of opposing first and second bulkheads.

The opposing bulkheads of each set are typically configured to provide an inward pressure upon gel cassettes assembled to the buffer core body engaged therebetween.

For example, in certain embodiments the bulkheads of each opposing set each comprises at least one upper protrusion, the protrusions configured to apply an inward pressure upon gel cassettes assembled to the buffer core engaged therebetween. In some embodiments, the bulkheads of each opposing set each further comprises at least one lower protrusion, the lower protrusions configured to apply an inward pressure upon gel cassettes assembled to the buffer core engaged therebetween.

In embodiments particularly useful in establishing a uniform field across each of the gels within positioned cassettes, at least one of the opposing bulkheads of each set includes a plurality of lower wedge-shaped protrusions, the plurality of wedge-shaped protrusions collectively making discontinuous contact to the cassette assembled to the buffer core engaged therebetween.

In typical embodiments, each of the bulkheads includes an aperture disposed through the bulkhead between its upper and lower protrusions.

In some embodiments, the thickness of each of the end walls of the container is greater than that of each of the side walls of the container.

In another aspect, the invention provides a container having a removable lid and a plurality of communicating chambers. Each of the plurality of chambers is configured to receive and engage a buffer core assembly. Each buffer core assembly preferably comprises a buffer core body and first and second cassettes securely coupled to front and back sides of the buffer core body. A space between the buffer core body and the first and second cassettes forms an upper buffer chamber, which is configured to receive a first buffer.

Each chamber in the container preferably is formed using first and second opposing bulkheads. The first and second bulkheads each have a laterally protruding upper region, recessed central region, and an aperture disposed through the recessed central region. Further, at least one wedge-shaped member is disposed beneath the aperture in the first bulkhead, and at least one wedge-shaped member is disposed beneath the aperture in the second bulkhead.

In application, each buffer core assembly is configured to be inserted between the first and second bulkheads of a desired chamber. As the buffer core assembly is inserted, the first and second gel cassettes contact the wedge-shaped members of the first and second bulkheads, respectively. This causes the first and second cassettes to be pressed inward towards the buffer core body. The pressure applied by the wedge-shaped members, along with the pressure applied by the laterally protruding upper regions of the bulkheads, provides an effective seal for the upper buffer chamber. Advantageously, since the wedge-shaped members are an integral component of the container, no moving clamping mechanisms are required to secure the gel cassettes in place and provide an effective seal between anode and cathode buffers.

In accordance with one aspect of the present invention, a common lower buffer chamber is formed when a plurality of buffer core assemblies are placed in adjacent chambers of the container. Specifically, the common lower buffer chamber is formed as a space between a second cassette of a first buffer core assembly and a first cassette of a second buffer core assembly, a second cassette of a second buffer assembly and a first cassette of a third buffer assembly, and so forth. Therefore, when a second buffer is poured into the common lower buffer chamber, the second buffer may be placed in fluid communication with each of the gel cassettes, regardless of the number of cassettes employed.

In a preferred method, each buffer core assembly to be used is inserted into a respective chamber of the container, then secured using the clamping force applied by the wedge-shaped members of the bulkheads, as described above. A predetermined volume of a first buffer then is poured into each upper buffer chamber, one at a time. In a next step, a corresponding predetermined volume of a second buffer is poured into the common lower buffer chamber at one location, then flows through various open spaces in the container to contact the outer surfaces of the gel cassettes in the container. In effect, the inner surfaces of each gel cassette are in contact with the first buffer in the upper buffer chamber, while the outer surfaces are in contact with the second buffer filling in the common lower buffer chamber.

In a next step, the removable lid is placed on top of the container. The removable lid is coupled to first and second cables, which are adapted to be coupled to a power supply or charging means. The removable lid also is electrically coupled to negative and positive wires that are in electrical contact with each of the first and second buffers, respectively.

When an electrical potential is applied across each of the negative and positive wires, an electric field on each of the gels in the container is developed. The electrical fields in the gels effect molecular separation of the electrophoresis samples in the gels The electrical fields in the gels effect molecular separation of the electrophoresis samples in the gels since the gels act as the only conductive path between the buffer solutions which are charged at opposite polarities.

In accordance with one aspect of the present invention, passive thermal management techniques are used to control the temperatures of the gels in the cassettes. The passive thermal management techniques rely on the heat sinking capabilities of the first and second buffers to maintain a relatively equal temperature on the outer and inner plates of the cassette. According to passive thermal management provided herein, the temperature between upper buffers in separate buffer cores within a container at the end of an electrophoretic separation is within 25, 20, 15, 10, 5, 4, 3, 2, or 1° C. Furthermore, the temperature difference between an upper buffer and a lower buffer is within 25, 20, 15, 10, 5, 4, 3, 2, or 1° C. at the end of an electrophoretic separation performed using the apparatus or methods. Furthermore, according to passive thermal management provided herein, the temperature between gels at the end of an electrophoretic separation is within 25, 20, 15, 10, 5, 4, 3, 2, or 1° C. In certain illustrative examples, the temperature between upper buffer cores, between upper and lower buffers, and between gels is within 10° C. at the end of an electrophoretic separation.

The heat sink principles that are used in conjunction with the present invention take into account several variables, including the specific heat of the buffers, the mass of the buffers added, the change in temperature, the current and voltage applied to the gels, and other variables. By knowing the voltage and current applied, knowing the time duration required to complete separation, knowing the specific heat of the buffer, and by calculating the mass of buffer to be added, the temperature increase of the gels can be kept below a predetermined threshold (for example, 60° C.). Furthermore, the apparatus and methods of the present invention ensure that the same temperature is maintained on the outer and inner surfaces of each gel cassette to avoid slanting of the migrating bands in a sample. The present invention also ensures that each gel in the apparatus is exposed to the same thermal environment as each of the other gels.

If desired, a dam system may be used in conjunction with the apparatus of the present invention to run fewer than the maximum number of gels that the container can run. The dam interrupts flow to certain areas of the common lower buffer chamber, based on its placement in the container. For example, if the container has the capacity to run six gels simultaneously, but a user only wishes to run two gels, the dam is positioned such that flow in the lower buffer chamber is interrupted to the other four regions of the container.

The dam system, which preferably is adapted to be coupled to the buffer core assembly in lieu of one of the cassettes, is configured to displace half the volume of an upper buffer chamber. Therefore, when an odd number of gels are being run, only one-half of buffer is poured into the upper buffer chamber, relative to when two cassettes are used in a buffer core assembly. Accordingly, a proportional amount of buffer is used, regardless of whether an even or odd number of gels are being run, thereby ensuring that the temperatures on the outer and inner surfaces of the cassettes will remain the same during electrophoresis.

### BRIEF DESCRIPTION OF THE DRAWINGS

Further features of the invention, its nature and various advantages will be more apparent from the accompanying drawings and the following detailed description of the preferred embodiments, in which:

FIGS. 1A-1B are, respectively, an exploded view of apparatus of the present invention and a sectional view of the container of FIG. 1A taken along longitudinal axis A-A;

FIGS. 2A-2C are, respectively, perspective views of a buffer core assembly of the present invention with no cassettes, the buffer core assembly with one gel cassette coupled thereto, and the buffer core assembly with two gel cassettes coupled thereto;

FIGS. 3A-3B are, respectively, front and side views of the buffer core assembly of FIGS. 2A-2C with no cassettes shown;

FIG. 4A-4B are, respectively, a front view of a gel cassette and a cross sectional view of the gel cassette taken along line B-B of FIG. 4A;

FIGS. 5A-5B are, respectively, a perspective view of the apparatus of FIG. 1A in an assembled state and a sectional view of the apparatus in the assembled state, as taken along longitudinal axis A-A of FIG. 1A; FIG. 5B illustrates for exemplary purposes the use of six gel cassettes without a dam;

FIG. 6 is an exploded view showing a removable lid that may be used in conjunction with apparatus of the present invention;

FIG. 7 is a perspective view showing the removable lid of FIG. 6 in an assembled state;

FIGS. 8A-8B are, respectively, front and rear perspective views of a dam that may be used in conjunction with apparatus of the present invention;

FIG. 9 is a perspective view depicting the dam of FIGS. 8A-8B coupled to a buffer core assembly; and

FIGS. 10A-10C are sectional views illustrating the dam of FIGS. 8-9 being used to block flow to various regions of the container of the present invention.

### DETAILED DESCRIPTION

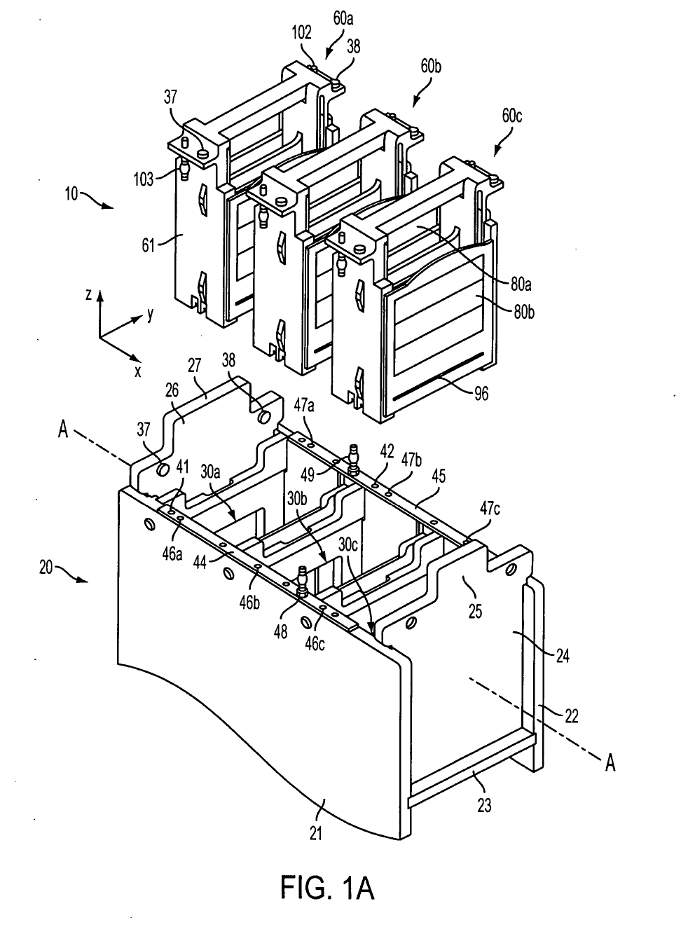

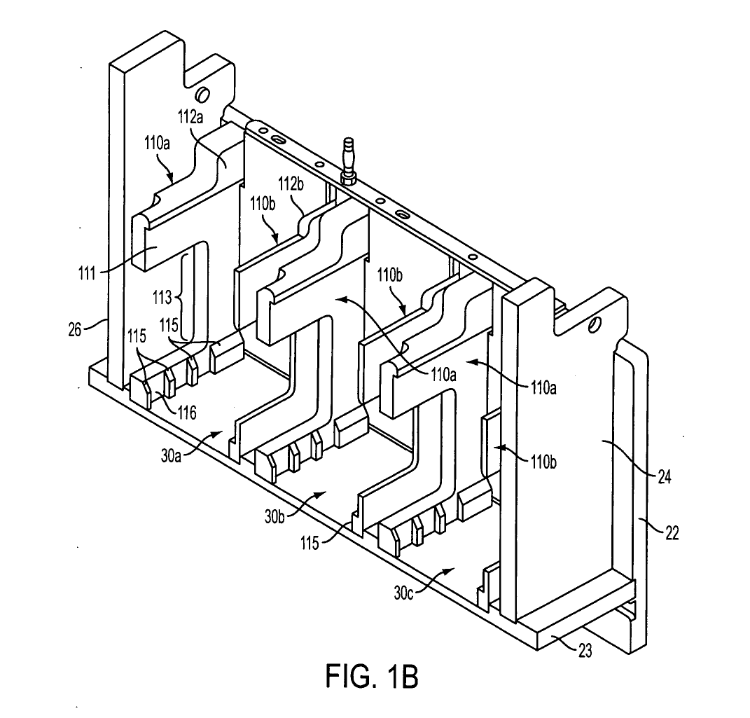

Referring now to FIGS. 1A-1B, apparatus and methods for performing multiple electrophoresis experiments in accordance with the present invention are described.

As shown in FIG. 1A, electrophoresis system 10 comprises container 20 having plurality of communicating chambers 30a-30c, and further comprises plurality of buffer core assemblies 60a-60c that correspond to respective chambers 30a-30c. Although three chambers and three buffer core assemblies are illustratively depicted herein, greater or fewer chambers and buffer core assemblies may be employed, as will be apparent to one skilled in the art from the following detailed description.

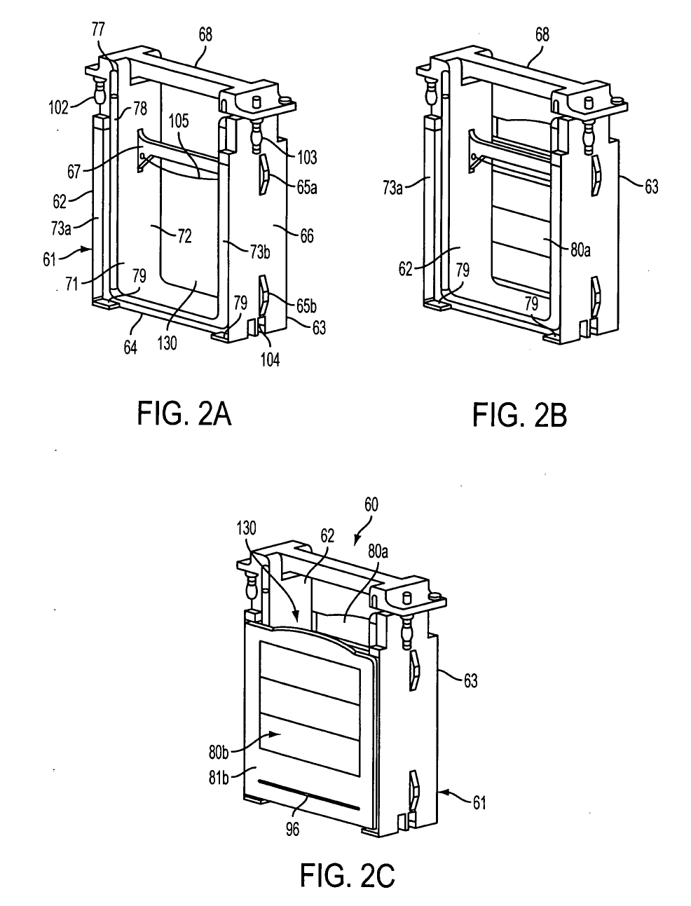

Container 20 preferably comprises first and second side walls 21 and 22, closed bottom 23, and first and second end walls 24 and 26, as shown in FIG. 1A. Container 20 is open at the top for receiving buffer core assemblies 60a-60c. Each buffer core assembly 60a-60c preferably comprises buffer core body 61 and a pair of gel cassettes 80a and 80b, as will be described in greater detail hereinbelow with respect to FIGS. 2A-2C.

Container 20 further comprises negative bus bar 44 and positive bus bar 45. Negative and positive bus bars 44 and 45 preferably are disposed atop first and second side walls 21 and 22, respectively, as shown in FIG. 1A. One or more screws 41, or other means for attaching the bus bars, may be inserted into corresponding holes 42 to secure the bus bars to the side walls.

Negative bus bar 44 is electrically coupled to pole conductor 48, and further coupled to plurality of sockets 46a-46c, which correspond to chambers 30a-30c of container 20. Positive bus bar 45 is electrically coupled to pole conductor 49, and further coupled to plurality of sockets 47a-47c, which correspond to chambers 30a-30c, respectively, as depicted in FIG. 1A.

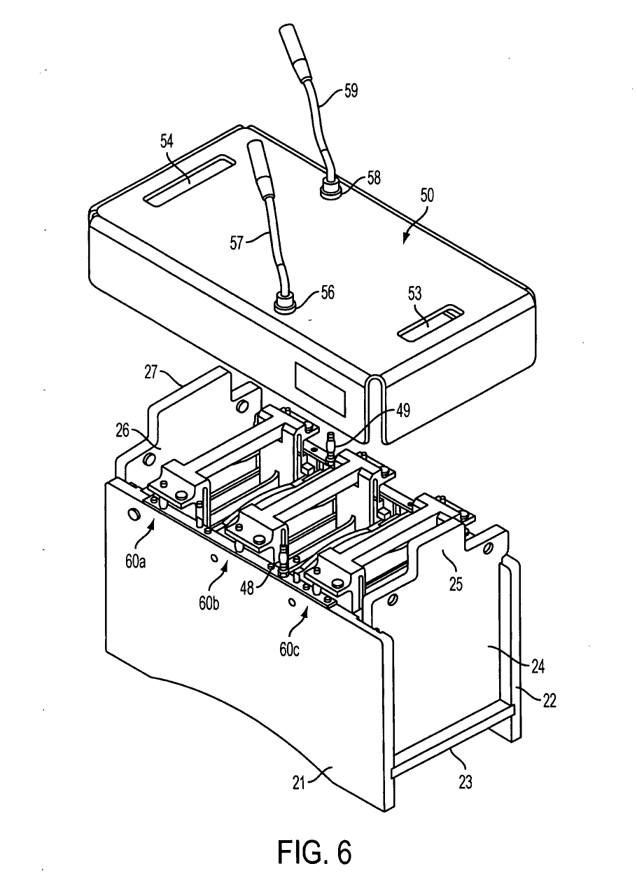

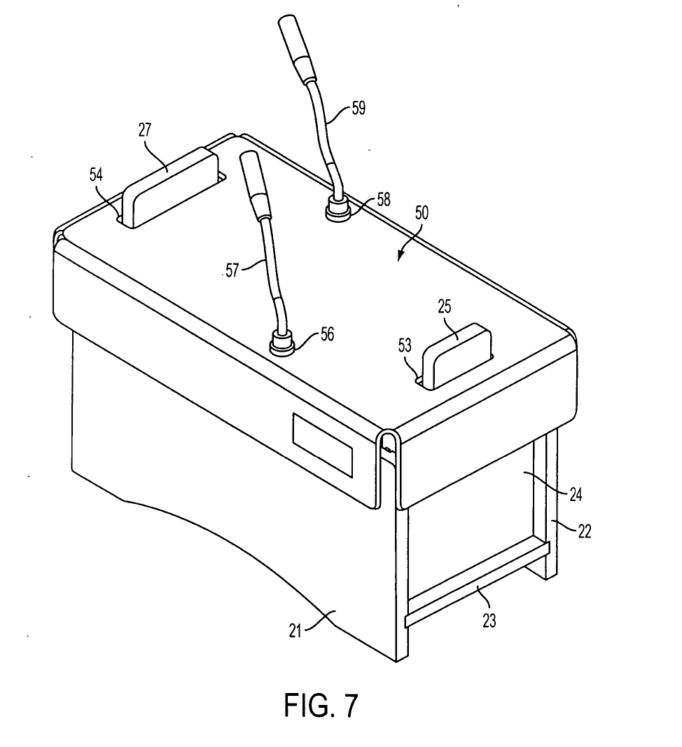

In a particularly useful embodiment of the present invention, black and red polarity tabs 37 and 38 are affixed to container 20 on opposing lateral sides of the container, as depicted in FIG. 1A, to visually facilitate proper electrical attachments of buffer core assemblies 60 and lid 50 (see FIG. 6). As can be seen in FIG. 1A, each buffer core assembly 60a-60c preferably comprises corresponding polarity tabs 37 and 38 to visually facilitate proper insertion of the buffer core assemblies into container 20.

Referring now to FIG. 1B, a sectional view of container 20 of FIG. 1A is illustrated to describe various internal features of electrophoresis system 10.

Container 20 has a plurality of chambers 30a-30c, which are adapted to receive buffer core assemblies 60a-60c, respectively. In a preferred embodiment, each chamber 30 is formed by first and second opposing bulkheads 110a and 110b. Each bulkhead 110 preferably comprises a laterally protruding (i.e., protruding along the X axis, see FIG. 1A) upper region 112 and a recessed central region 111 having an aperture 113 disposed therethrough, as depicted in FIG. 1B.

Each bulkhead 110 further preferably comprises at least one wedge-shaped member 115 disposed beneath apertures 113. The wedge-shaped member preferably is manufactured using a suitable substantially noncompliant compound, such as plastic.

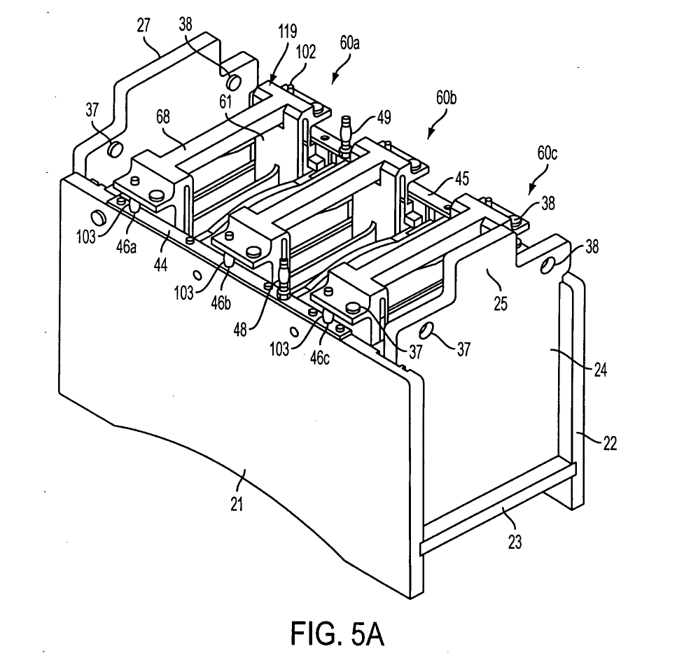

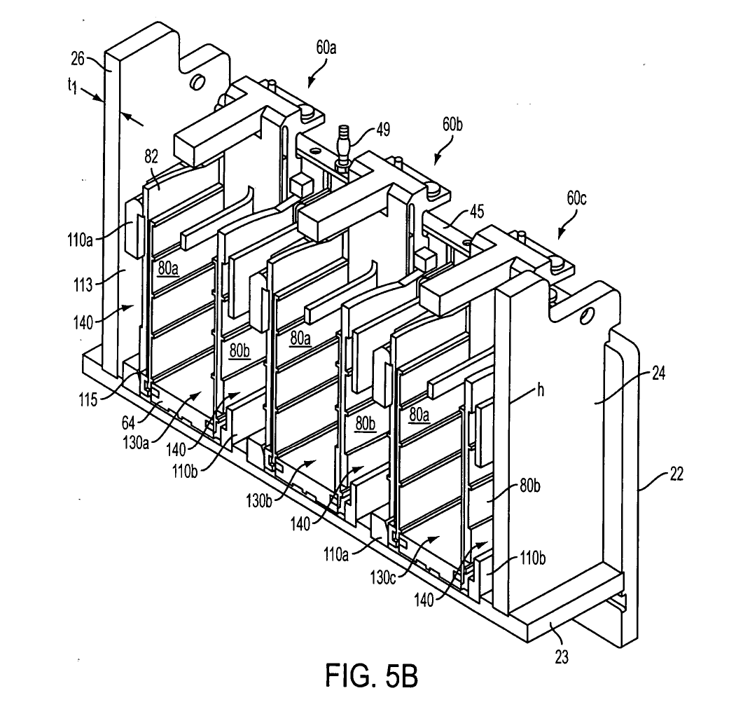

First and second bulkheads 110a and 110b have substantially identical configurations, with the main exception that laterally protruding upper region 112a of first bulkhead 110a is situated slightly higher with respect to the side walls of container 20 than laterally protruding upper region 112b of second bulkhead 110b. The slight height differential facilitates insertion of buffer core assemblies 60a-60c, because the buffer assemblies may be initially inserted at a slight vertical angle. The slight vertical angle allows the buffer core assemblies to slide into their respective chambers with little or no frictional interference, until each buffer core assembly contacts the wedge-shaped members at the bottom of the chamber. When each buffer core assembly contacts the wedge-shaped members, the wedge-shaped members force a vertical positioning of the buffer core assembly, as described in greater detail hereinbelow with respect to FIGS. 5A-5B, due to the clamping action between the two opposing lower wedges 115 and also between the two opposing upper protrusions 112.

Referring now to FIGS. 2-4, preferred features of buffer core assembly 60 and gel cassettes 80 are described in greater detail. Each buffer core assembly 60 preferably comprises buffer core body 61 and a pair of gel cassettes 80a and 80b, as shown in FIG. 2C.

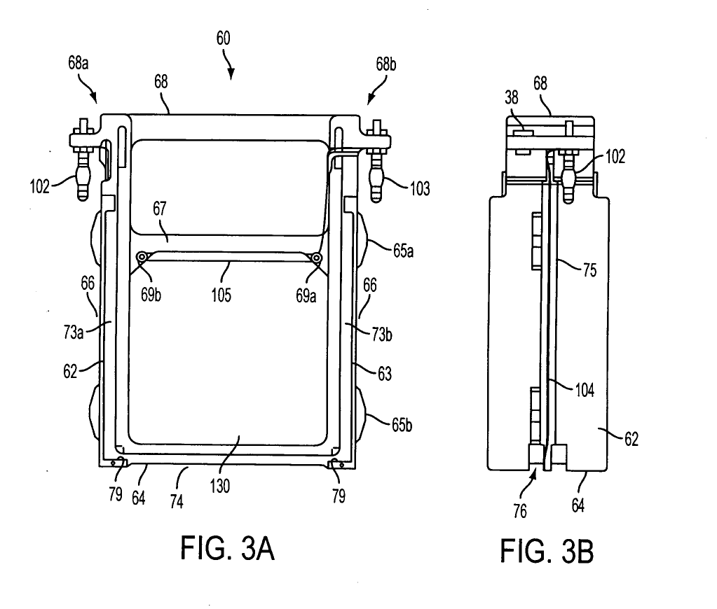

Buffer core body 61 comprises upraised side walls 62 and 63, and lower base 64 disposed between the side walls, as shown in FIG. 2A. Buffer core body 61 further comprises handle 68 and horizontal beam 67 disposed between upraised side walls 62 and 63. First and second male conductors 102 and 103 are securely coupled to outer regions 68a and 68b of handle 68, respectively, as shown in FIG. 3A.

First male conductor 102 is coupled to wire 104. A portion of wire 104 runs in groove 75, which is formed in a lateral surface of side wall 62, as shown in FIG. 3B. Wire 104 continues to run underneath buffer core body 61 via base channel 76. Wire 104 preferably spans a substantial portion of base channel 76, and is coupled to lower base 64 using a loop attachment to the underside of lower base 64. In this manner, wire 104 may be exposed to a buffer that is disposed on the exterior of side wall 62 and underneath buffer core body 61, as will be described in detail hereinbelow.

Second male conductor 103 is coupled to wire 105. Wire 105 runs through first aperture 69a of horizontal beam 67, and continues to extend through second aperture 69b at the other end of beam 67, as depicted in FIG. 3A. Wire 105 is coupled to horizontal beam 67 of buffer core body 61, preferably using a loop attachment.

Buffer core assembly 60 further comprises first and second recesses 73a and 73b, which are disposed in side walls 62 and 63, respectively. Recesses 73a and 73b are disposed on front side 71 of buffer core body 61, as shown in FIGS. 2A and 3A, and also are disposed in side walls 62 and 63 on back side 72 of buffer core body 61.

In application, first gel cassette 80a is placed in the recesses that are disposed on back side 72 of buffer core body 61, as depicted in FIG. 2B. Second gel cassette 80b then is placed in recesses 73a and 73b on front side 71 of buffer core body 61, as depicted in FIG. 2C. Each gel cassette rests upon base supports 79, which are provided on front and back sides 71 and 72 of buffer core body 61.

Upper buffer chamber 130 is formed between first gel cassette 80a, second gel cassette 80b, and side walls 62 and 63 of buffer core body 61, as depicted in FIG. 2C. Upper buffer chamber 130 is configured to receive a first buffer, such that the first buffer is placed into submerged contact with wire 105 to provide a charged buffer, as described in greater detail hereinbelow.

Referring back to FIG. 2A, front and back sides 71 and 72 of buffer core body 61 preferably are provided with U-shaped grooves 77, which are configured for fitting and holding one or more resilient strips 78 as a fluidic seal between gel cassettes 80b and 80a, respectively, and buffer core body 61. The seal provided by resilient strips 78 ensures electrical and fluidic isolation of the first buffer disposed in upper chamber 130 with a second buffer that is disposed in a lower chamber, as described in detail hereinbelow.

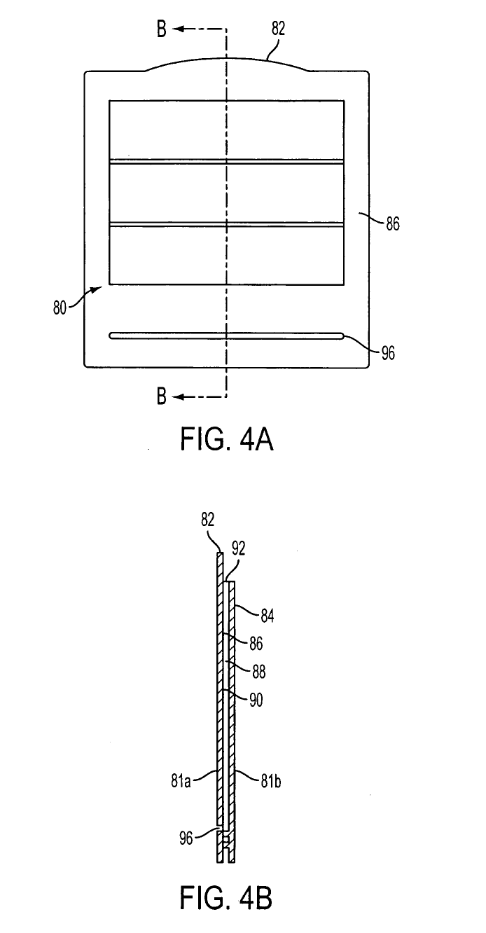

Referring now to FIGS. 4A-4B, features of gel cassettes 80 are described in greater detail. Each gel cassette 80a and 80b is substantially identical, and has an outer surface 81a and an inner surface 81b. It includes a pair of plates that are of thin wall construction. The plates are commonly referred to as the divider or divider plate 82 and retainer or retainer plate 84. Retainer plate 84 is slightly shorter in height than the divider plate 82.

Divider 82 is affixed to peripheral ridge 86 along the lateral sides and the bottom periphery of retainer 84 to define an internal gel compartment 88 for holding an electrophoresis gel 90. As shown in FIG. 4B, gel compartment 88 has a top or comb opening 92 at the top portion of the cassette for receiving a sample to be electrophoretically separated.

Located along the lower portion of divider plate 82 and traversing the width of cassette 80 is a slot or opening 96 that opens gel compartment 88 to the exterior of cassette 80 and hence allows a direct electrical coupling with the charged buffer solution.

Gel cassettes suitable for the present invention are known in the art. In a typical gel cassette, the gel is pre-filled within the internal gel compartment for ease of handling. Top opening 92 is closed with a comb (not shown), and slot 96 is masked closed with a removable tape (not shown). An example of the gel cassettes that are suitable for this application are the 12% Tris-glycine gels sold by INVITROGEN CORPORATION of Carlsbad, Calif., under catalog No. EC6005. Gel cassettes of similar types also are commercially available from other firms.

Prior to use of cassette 80, the comb (not shown) and the tape (not shown) disposed over top opening 92 and slot 96, respectively, are removed. The sample to be analyzed is introduced into gel compartment 88 through comb opening 92 by an appropriate means, such as a pipette. The cassettes with their retainer plates 84 proximal to buffer core body 61 are held to rest within side recesses 73 and base supports 79, as described hereinabove with respect to FIGS. 2A-2C. One or more buffer core assemblies 60 then are slidably inserted into a desired chamber 30, i.e., one of chambers 30a-30c, as depicted in FIG. 1A.

Referring now to FIGS. 5A-5B, plurality of buffer core assemblies 60a-60c are shown securely disposed in container 20 of FIGS. 1A-1B. During insertion of buffer core assemblies 60a-60c into chambers 30a-30c, laterally protruding upper regions 112a and 112b of opposing bulkheads 110a and 110b, respectively, apply an inward pressure against first and second cassettes 80a and 80b of each buffer core assembly. In effect, laterally protruding upper regions 112a and 112b serve to guide the buffer core assemblies into their respective chambers.

As each buffer core assembly further is inserted into its respective chamber 30, each gel cassette 80 is urged in an inward direction, i.e., towards buffer core body 61, by a force applied by wedge-shaped members 115, as shown in FIG. 5B. At this time, each gel cassette 80 is pressed firmly against resilient strips 78 (see FIGS. 2A-2C). In particular, first cassette 80a is pressed firmly against strips 78 by forces applied by wedge-shaped members 115 and laterally protruding upper region 112a, while second cassette 80 is pressed firmly against strips 78 by forces applied by wedge-shaped members 115 and laterally protruding upper region 112b.

The forces applied by wedge-shaped members 115 against gel cassettes 80a and 80b ensure fluidic and electrical isolation between a second buffer present in common lower buffer chamber 140 and a first buffer present in each of the individual upper buffer chambers 130a-130c. Fluidic and electrical isolation of first and second buffers reduces the risk of electrical grounding of the power supply or other sensitive instruments used in connection with the electrophoresis.

At about the same time that each buffer core assembly is securely wedged into its chamber, male conductors 102 of buffer core assemblies 60a-60c engage respective sockets 47a-47c (see FIG. 1A) of positive bus bar 45. Similarly, male conductors 103 of buffer core assemblies 60a-60c engage respective sockets 46a-46c of negative bus bar 44.

It should be noted that both male conductors 102 and 103 are disposed on front portion 119 of buffer core body 61, as depicted in FIG. 5A. This allows male conductors 102 to align with sockets 47a-47c, and male conductors 103 to align with sockets 46a-46c, but not vice versa. Therefore, each buffer core assembly 60a-60c cannot be wedged into chambers 30a-30c unless buffer core assemblies 60a-60c are properly oriented, thereby ensuring proper electrical connections. As noted above, black and red polarity tabs 37 and 38 may be positioned on container 20 and buffer core assemblies 60a-60c, as depicted, to further facilitate proper alignment of the buffer core assemblies by appropriate visual cues.

Referring to FIG. 5B, when a plurality of buffer core assemblies 60 are securely placed in container 20, a common lower buffer chamber 140 is formed. Specifically, common lower buffer chamber 140 is formed between second cassette 80b of first buffer core assembly 60a and first cassette 80a of second buffer core assembly 60b, as depicted in FIG. 5B. Common lower buffer chamber 140 also is formed between second cassette 80b of second buffer core assembly 60b and first cassette 80a of third buffer core assembly 60c. Further, common lower buffer chamber 140 is formed between first cassette 80a of buffer core assembly 60a and end wall 26, and between outer cassette 80b of buffer core assembly 60c and end wall 24, as depicted in FIG. 5B.

In accordance with one aspect of the present invention, lower buffer chamber 140 allows a second buffer (not shown) to be placed in contact with each buffer core assembly 60a-60c. When the second buffer is poured into any region of lower buffer chamber 140, the second buffer will be distributed in a substantially equal fashion to the other regions of lower buffer chamber 140. Specifically, the second buffer will flow through apertures 113 in bulkheads 110a and 110b (see FIG. 1B), between wedge-shaped members 115 via channels 116 (see also FIG. 1B), underneath lower buffer core base 64 via channel 74 (see FIG. 3A), and around buffer core side walls 62 and 63 via side channels 66 (see FIG. 3A). It should be noted that side walls 62 and 63 of buffer core body 61 preferably comprise spacers 65a and 65b, as shown in FIG. 3A, that are configured to contact a side wall of container 20. Therefore, when buffer core assembly 60 is disposed in chamber 30, channel 66 is formed between the side walls of the buffer core body and the side walls of the container to permit flow of the second buffer therebetween.

Referring still to FIGS. 5A-5B, in application buffer core assemblies 60a-60c are first secured within container 20 in the manner as described above. A predetermined volume of a first buffer (not shown) is then typically dispensed separately into each upper buffer chamber 130a-130c above the comb openings 92 of the cassettes to establish fluid contact with gel 90 in the gel compartments.

A corresponding, predetermined volume of a second buffer (not shown) then is introduced into lower buffer chamber 140 of container 20. Pouring the predetermined volume of the second buffer into any region of lower buffer chamber 140 will cause the second buffer to be distributed substantially equally throughout chamber 140. It should be noted that, in alternative embodiments, the second buffer may be added before the first buffer is added.

Container 20 is configured such that the volumes between assemblies 60a and 60b, and between 60b and 60c are approximately twice as great as the volumes between cassette 80a of assembly 60a and end wall 26, and between cassette 80b of assembly 60c and end wall 24. Therefore, when the second buffer poured into lower buffer chamber 140 settles to a height h, approximately twice as much second buffer will settle between the adjacent buffer core assemblies as will settle between assembly 60a and end wall 26, and assembly 60c and end wall 24.

For example, if 600 mL of the second buffer is poured into lower buffer chamber 140, then after the buffer settles in container 20, approximately 100 mL of the second buffer will settle between first cassette 80a of assembly 60a and end wall 26, approximately 200 mL of the second buffer will settle between assemblies 60a and 60b, approximately 200 mL will settle between assemblies 60b and 60c, and approximately 100 mL will settle between second cassette 80b of assembly 60c and end wall 24. Therefore, each outer surface of each cassette 80 will have approximately 100 mL of second buffer devoted as a heat sink disposed adjacent the outer surface.

In a preferred embodiment of this aspect of the present invention, components of container 20 are dimensioned so that equal volumes of second and first buffers are devoted as heat sinks for the outer and inner surfaces 81a and 81b of each gel cassette 80a. Therefore, as an example, if 600 mL of second buffer is poured into common lower buffer chamber 140, as described above, then 200 mL of first buffer should be poured into each upper buffer chamber 60a-60c. Since there are six gel cassettes in container 20, and two cassettes per upper buffer chamber, then the inner surfaces of each of the six cassettes will have approximately 100 mL of first buffer devoted as a heat sink to the inner surfaces of the cassettes.

As will be described in greater detail hereinbelow, the actual volumes of first and second buffers may be selected to ensure adequate heat sinking during electrophoresis to keep the temperature of gel 90 below a predetermined threshold.

Referring now to FIG. 6, removable lid 50 is positioned above the top portion of container 20 such that female electric plugs 56 and 58 are aligned with pole conductors 48 and 49, respectively. As the lid is lowered onto container 20, the female plugs are coupled with the pole conductors, thereby securing the lid to seat upon the top portion of container 20.

Asymmetric mating of removable lid 50 with container 20 preferably is employed to ensure a proper electrical connection. Specifically, in one embodiment, lid 50 will only fit onto container 20 when slot 53 can fit over short tab 25, and slot 54 can fit over long tab 27, as illustrated in FIG. 7. Thus, as lid 50 is lowered, female electric plug 56 must be aligned with pole conductor 48, and female electric plug 58 with pole conductor 49, but not vice versa, to ensure proper electrical connections. In a preferred embodiment of the present invention, lid 50 is transparent to facilitate viewing and evaluation of the gels as they are being run, as described hereinbelow.

After lid 50 is seated, conductor cables 57 and 59 are coupled to a power supply system or charging means for delivering an appropriate electrical potential to the electrophoresis system. In one embodiment of the present invention, cable 57 is coupled to the power supply to deliver a negative potential, and cable 59 to deliver a positive potential. In practice, the polarity of the electrical potential can be reversibly applied to the buffers, as a matter of choice.

As a negative electrical potential is applied across pole conductor 48, the electrical charge also is applied across each wire 105 (see FIG. 3A), since each wire 105 is coupled to a male conductor 103, and each male conductor 103 is electrically coupled to a socket 46a-46c of negative bus bar 44. Similarly, a positive electrical potential applied across pole conductor 49 also is applied across each wire 104 (see FIG. 3B), since each wire 104 is coupled to a male conductor 102, and each male conductor 102 is electrically coupled to a socket 47a-47c of positive bus bar 45.

This in turn imposes an electrical potential difference between the first buffer, which is in contact with wire 105, and the second buffer, which is in contact with wire 104. Accordingly, the first buffer is negatively charged, while the second buffer is positively charged.

As discussed hereinabove, gel 90 of cassettes 80a and 80b is in contact with the first buffers (in upper buffer chambers 130a-130c), and gel 90 is also in contact with the second buffer in common lower buffer chamber 140. Therefore, the electrically charged buffers will result in an electrical field in gel 90 between top opening 92 and slot 96 to effect molecular separation of analytes in the sample.

For optimally reproducible results among gels run concurrently, the electric field provided to each gel should be substantially identical; and for optimal separation within a gel, the electric field should be homogeneous across the gel (i.e., in the direction perpendicular to the direction of analyte migration).

The apparatus of the present invention provides advantages with respect to both of these parameters in part by the design of container 20, and in part by the placement of wires 105, which span the length of the underside of buffer core body 61 (in direction y; as described hereinabove).

In particular embodiments of container 20, at least one of opposing bulkheads 112a and 112b of each set includes a plurality of lower wedge-shaped protrusions 115, rather than a single wedge-shaped protrusion 115 that extends across the width of bulkhead 112. The plurality of wedge-shaped protrusions 115 collectively make discontinuous contact with the cassette assembled to the buffer core engaged between the bulkheads, creating channels 116 (see FIG. 1B). Channels 116 facilitate the reconvergence of the electric field at the level of cassette slot 96, facilitating homogeneity across the gel.

By spanning the underside of buffer core body 61, wires 105 provide a uniform electric field across the gel cassettes in direction y. Moreover, wires 105 are situated within container 20 such that they provide a substantially uniform electric field to all gel cassettes.

As mentioned hereinabove, heat is generated during electrophoretic molecular separation within gel 90, thus creating uneven temperature gradients on the surfaces of the gel, as well as across its thickness. Such problem is effectively mitigated by controlling the surface temperature of the gel cassettes.

Unlike previously-known apparatus and methods that actively circulate a coolant to control temperature, the present invention employs passive thermal management techniques to effect temperature control of the surface temperatures of gel cassettes 80. In particular, the dimensions of the apparatus are configured to permit first and second buffers to serve as heat sinks during electrophoresis, when the first and second buffers are disposed in upper buffer chambers 130a-130c and common lower buffer chamber 140, respectively. This temperature control is achieved for electrophoretic separation concurrently in a plurality of gels, by using passive thermal management to avoid the need for complex, ineffective or cumbersome active cooling mechanisms. According to passive thermal management provided herein, the temperature between upper buffers in separate buffer cores within a container at the end of an electrophoretic separation is within 25, 20, 15, 10, 5, 4, 3, 2, or 1° C. Furthermore, the temperature difference between an upper buffer and a lower buffer is within 25, 20, 15, 10, 5, 4, 3, 2, or 1° C. at the end of an electrophoretic separation performed using the apparatus or methods provided herein. Since this is typically the maximum temperature difference, the difference during an electrophoresis run is not as great. In one illustrative example, the temperature difference between an upper buffer and a lower buffer, and the temperature between upper buffers of separate buffer cores in the same container, is within 10° C. at the end of an electrophoretic separation performed using the apparatus or methods provided herein. The temperature of the lower buffer can be measured between buffer cores, but in certain illustrative aspects is measured in front of, or in back of, the buffer cores. The front and back lower buffer regions are expected to have a greater temperature differential with the upper buffer than the lower buffer between buffer cores.

The heat sink principles that are used to select dimensions of the apparatus of the present invention rely primarily on the heat transfer principle that the amount of heat added (“Q”) is equal to the product of specific heat of a substance (“c”), the mass of the substance(“m”) and the change in temperature (“ΔT”, or “T_{final}−Tᵢₙᵢₜᵢₐₗ”)

With respect to the present invention, the amount of heat added Q to the gels can be approximated by determining the product of the current (“i”) and voltage (“V”) that are applied. Therefore, since current i and voltage V are known quantities, the approximate amount of heat added Q to each of the gels can be determined.

The approximate amount of heat added Q then is set equal to the product of specific heat of the buffer c, mass of the buffer m, and change in temperature ΔT (T_{final}−Tᵢₙᵢₜᵢₐₗ). Since the specific heat of the buffer c is known, and the change in temperature is ascertainable (i.e., the initial temperature is known, and the final temperature is selected by the user), then the mass of the buffer to be added can be calculated.

Therefore, a user can determine how much first and second buffer should be added to keep the temperature increase of gels 90 below a predetermined threshold (i.e., T_{final}, such as 60° C.). Accordingly, in an other embodiment of the present invention, a method is provided for determining a volume of buffer to add to a cathode buffer reservoir or upper buffer reservoir, and the volume of buffer to add to an anode buffer reservoir, or lower buffer reservoir. The method includes selecting a target final temperature for a buffer and identifying an initial temperature for the buffer, and calculating a volume of buffer to add using a change in temperature between the target final temperature and the initial temperature and a specific heat of the buffer.

In application, it is desirable to maintain approximately the same temperature on outer and inner surfaces 81a and 81b of cassettes 80 (+/−25, 20, 15, 10, or 5° C. during a run to avoid slanting of the migrating bands in a sample. In a preferred embodiment of the present invention, the specific heat of the first and second buffers are within 25%, 20%, 15%, 10%, 5%, substantially identical, or identical. Therefore, to maintain approximately the same temperature on both sides of the cassette, the volume of first buffer devoted as a heat sink to each inner surface 81b is 50% to 150%, 75% to 125%, 85% to 115%, or 90% to 110% of the volume of second buffer devoted as a heat sink to each outer surface 81a.

Also, since heat is transferred to the effective heat sinks through faces of the cassettes, the inner and outer faces of the cassettes preferably are equal in area. Therefore, the heat flux out of one face is equal to the heat flux out of the other face, so long as the heat sink temperatures are equal.

In a preferred embodiment of the present invention, end walls 24 and 26 of container 20 each comprise thickness t₁, as depicted in FIG. 5B, which is greater than a structural thickness required to support the lid and contain the lower buffer in lower buffer chamber 140. The enhanced thickness t₁ of end walls 24 and 26 serves to insulate the lower buffer in lower buffer chamber 140 from convective or radiant heat loss due to lower temperatures present outside of the container.

In particular, enhanced thickness t₁ of end walls 24 and 26 serves to insulate the lower buffer present between end wall 26 and first cassette 80a of buffer core assembly 60a, and between end wall 24 and second cassette 80b of buffer core assembly 60c; these end volumes of buffer have greater exposure to a wall of container 20 than do volumes defined further internal to container 20. By appropriately increasing the thickness of the end walls, increasing their insulating capacity, the temperature of the lower buffer present in the vicinity of end walls 24 and 26 is within 25° C. to the temperature of the lower buffer present in interior regions of container 20, thereby facilitating consistent runs for all gels in the container.

Similarly, side walls 21 and 22 of container 20 may have a chosen thickness designed to reduce radiant or convective heat loss through the side walls. However, if desired, side walls 21 and 22 may have a reduced thickness that allows for some heat loss through the side walls. In such cases, the heat loss may be accounted for in thermal calculations to ensure that a desired buffer temperature is achieved. Because side walls 21 and 22 are common to all chambers (or apportioned volumes), the lower buffer present in lower buffer chamber 140 will still have a temperature throughout all regions of container 20 that is within 35° C., 25° C., 15° C., 10° C., or 5° C., thereby facilitating relatively consistent electrophoretic conditions regardless of the number of gels being run.

As described hereinabove, container 20 is configured such that the volumes between assemblies 60a and 60b, and 60b and 60c are approximately twice as great as the volumes between cassette 80a of assembly 60a and end wall 26, and cassette 80b of assembly 60c and end wall 24. Therefore, when the second buffer poured into lower buffer chamber 140 settles to a height h, approximately twice as much second buffer volume will settle between the adjacent buffer core assemblies as will settle between assembly 60a and end wall 26, and assembly 60c and end wall 24. In the example described hereinabove, if 600 mL of the second buffer is poured into lower buffer chamber 140, then after the buffer settles in container 20, approximately 100 mL of the second buffer will settle between first cassette 80a of assembly 60a and end wall 26, approximately 200 mL of the second buffer will settle between assemblies 60a and 60b, approximately 200 mL will settle between assemblies 60b and 60c, and approximately 100 mL will settle between second cassette 80b of assembly 60c and end wall 24. Therefore, each outer surface 81a of each cassette 80 will have approximately 100 mL of second buffer devoted as a heat sink disposed adjacent the outer surface.

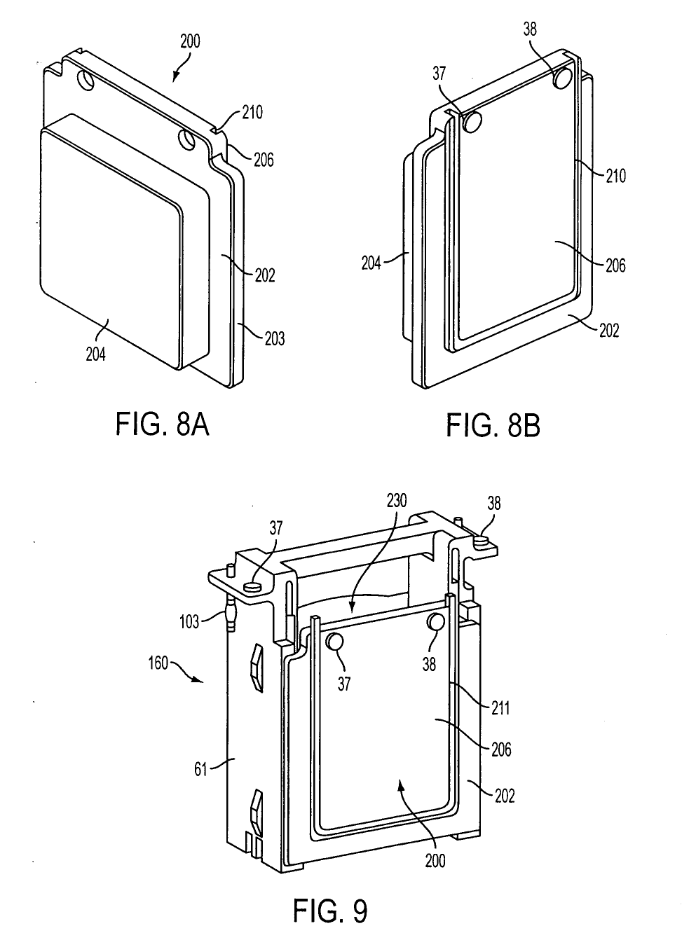

Since the apparatus of the present invention is configured to simultaneously run any number of gels, temperature control is scalable to the number of gels being run. Advantageously, by placing a dam into the system to seal off the unused regions, as described hereinbelow with respect to FIGS. 8-10, a proportional volume of the second buffer can always be poured into lower buffer chamber 140, regardless of the number of gels being run, to maintain a proper heat sink on the outer surface of each cassette being run. By “proportional volume” or “proportionate volume,” is meant that a volume of buffer is added to a buffer chamber such that the volume per gel is maintained within 75% of each other. In other words, if 100 milliliters of a lower buffer is used when two gels are included within an apparatus disclosed herein, then no less than 75 milliliters per gel of lower buffer would be used when three or more gels are present within the apparatus. In another aspect, a volume of buffer is added to a buffer chamber such that the volume per gel is maintained within 80%, 85%, 90%, 95%, or 99% of each other. In certain illustrative examples, when 6 gels are present within the apparatus, 640-700 milliliters of lower buffer is used, when 5 gels are present within the apparatus 550-610 milliliters of lower buffer are used, when 4 gels are present within the apparatus 480-520 milliliters of buffer are used, when 5 gels are present within the apparatus 340-380 milliliters of buffer are used. In another illustrative embodiment, between 75 and 150 milliliters of lower buffer are used per gel in the apparatus, between 100 and 135 milliliters, between 110 and 130 milliliters per gel, or in certain illustrative embodiments, between 112 and 125 milliliters per gel. In the illustrative examples discussed above, when 2 gels are present within a buffer core of the apparatus, between 225 and 275, for example 250 mLs of upper buffer are used. When 1 gel is present within a buffer core of the apparatus, between 150 and 180 mLs, for example 165 mLs, of upper buffer are used.

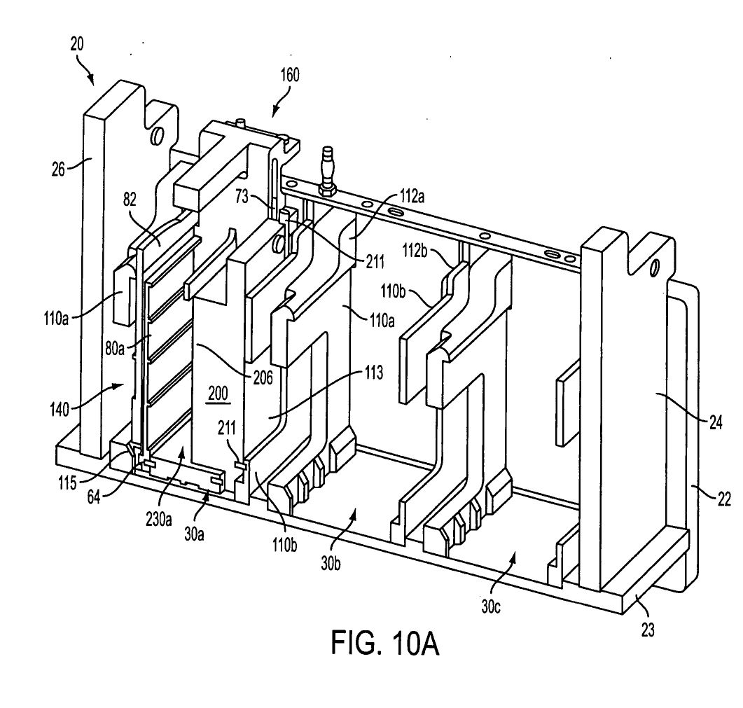

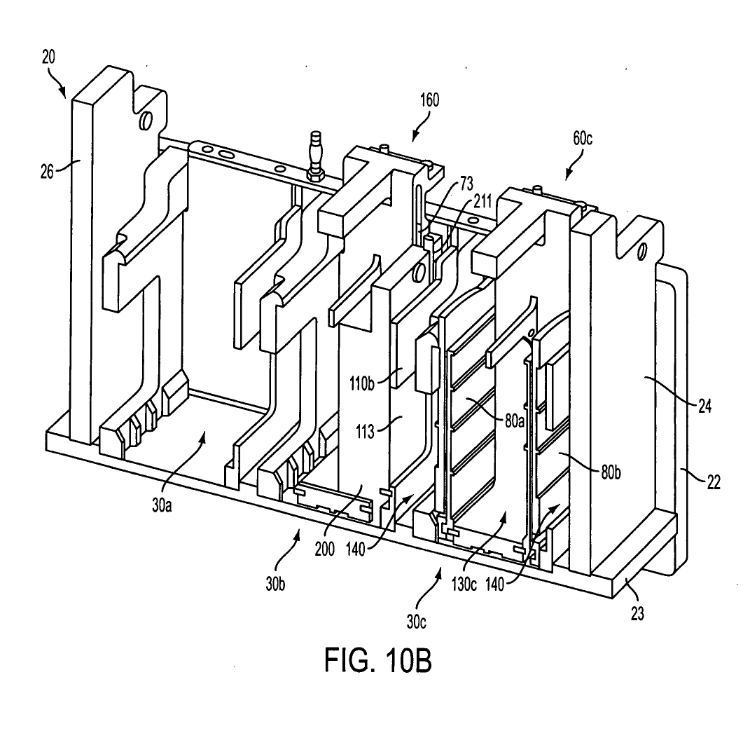

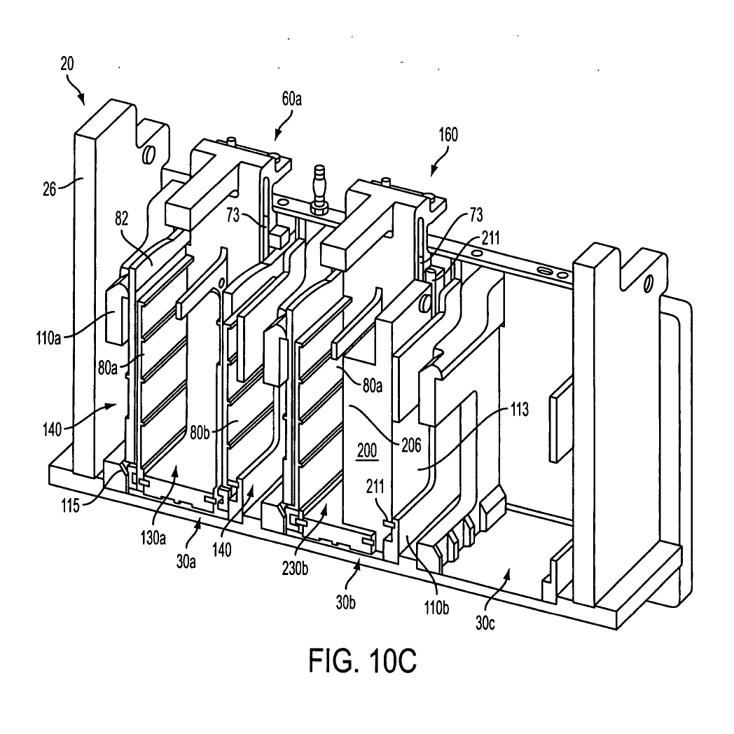

In one example, if only two gels are being run, as described in FIG. 10B hereinbelow, then 225 mL of second buffer can be poured into lower buffer chamber 140. If three gels are being run, then 360 mL of second buffer can be poured into lower buffer chamber 140. Since the dam described hereinbelow prevents the flow of second buffer into the unused regions of the container, the level of the buffer will still rise to a level that is close to, or exactly at ‘h’. Therefore, the outer surface of each cassette will always have approximately 125 mL +/−25% of second buffer devoted as a heat sink, regardless of the number of gels being run.

Referring now to FIGS. 8-10, a dam system that may be used in conjunction with electrophoresis system 10 of FIGS. 1-7 is described. The dam system is used to control the volume of buffer used as a heat sink for the upper buffer chamber and lower buffer chamber. For example, when a dam is used between 30% and 80%, 40% and 75%, 40% and 70%, 50% and 70%, or 60% and 70% of the volume of the first buffer are poured into the upper buffer chamber in the presence versus absence of the dam. Container 20 can run a maximum number of gels 90 simultaneously. In the embodiments described hereinabove, container 20 is depicted as having the capability of running a maximum of six gels simultaneously, although it will be apparent to one skilled in the art that the maximum capacity may be greater or fewer than six gels. When a user wishes to run fewer gels than the maximum capacity, flow to other regions of the container must be interrupted to ensure that the proper volume of second buffer in lower buffer chamber 140 is devoted as a heat sink to each of the gel cassettes that are actually being used.

Referring now to FIGS. 8A-8B, dam 200, which may be employed to interrupt flow to unused regions of container 20, preferably comprises central section 202, protruding front section 204, and rear section 206. Dam 200 is configured to engage buffer core body 61 such that outer portion 203 of central section 202 is positioned in recesses 73a and 73b (see FIG. 3A) of buffer core body 61. Outer portion 203 is positioned against resilient strips 78 of FIG. 2A in a manner similar to the positioning of gel cassettes 80a and 80b, as described hereinabove. When outer portion 203 is positioned in recesses 73a and 73b, and rests upon base support 79, protruding front section 204 extends approximately halfway into upper buffer chamber 230 of buffer core assembly 160, as depicted in FIGS. 10A-10C hereinbelow. Therefore, upper buffer chamber 230 of buffer core assembly 160 has only half the volume as upper buffer chamber 130 of buffer core assembly 60, which employs two cassettes.

At this time, rear section 206 of dam 200 faces away from upper buffer chamber 230. Rear section 206 preferably has a U-shaped slot 210 configured to receive and hold resilient strip 211, as shown in FIG. 9. As will be described in further detail hereinbelow, resilient strip 211 is configured to engage bulkhead 110b such that flow to aperture 113 of the bulkhead is inhibited.

Red and black polarity tabs 37 and 38 may be disposed on opposing lateral sides of dam 200 to facilitate coupling of dam 200 to buffer core body 61 in a proper orientation, as depicted in FIG. 9.

Referring now to FIGS. 10A-10C, illustrative uses of dam 200 in container 20 are described. In FIG. 10A, an arrangement is described whereby a user can run only one gel in container 20. Buffer core assembly 160 has first gel cassette 80a coupled to front side 71 of buffer core body 61, and dam 200 coupled to back side 72 of buffer core body 61. Buffer core assembly 160 is inserted into chamber 30a of container 20 as described hereinabove. Specifically, buffer core assembly 160 is inserted between laterally protruding regions 112a and 112b of bulkheads 110a and 110b, respectively, and then urged downward. Wedge-shaped members 115 then urge cassette 80a and dam 200 in an inward direction against resilient strips 78, thereby securing buffer core assembly 160 within chamber 30a of container 20.

In FIG. 10A, since only one gel is being run, dam 200 is employed to block flow to the rest of container 20. In accordance with one aspect of the present invention, U-shaped strip 211 of dam 200 helps ensure that the second buffer in lower buffer chamber 140 does not flow into chambers 30b and 30c, which would compromise the heat sinking ability of the second buffer when only one gel is run.

In a next step, a first buffer (not shown) then is poured into upper buffer chamber 230a, and a second buffer (not shown) is poured into lower buffer chamber 140. Since only one gel is being run in buffer core assembly 160, only one-half of the volume of the first buffer is required in upper buffer chamber 230a, relative to using two gel cassettes in the buffer core assembly. This is because front section 204 of dam 200 protrudes halfway into upper buffer chamber 230a, as shown in FIB. 10A.

For example, when 100 mL of first buffer is poured into upper buffer chamber 230a, 100 mL of second buffer is poured into lower buffer chamber 140 between the outer surface of cassette 80a and end wall 26. Therefore, 100 mL of first and second buffers are devoted as heat sinks for the inner and outer surfaces of cassette 80a. Accordingly, the temperature on outer and inner surfaces 81a and 81b of cassette 80a will be within 25° C., 15° C., 10° C., or 5° C. during electrophoresis.

Protruding front section 204 of dam 200 preferably is configured to reduce radiant or convective heat loss through the dam. For example, a sufficient thickness associated with protruding front section 204 may be selected to reduce heat loss through the dam. This approach is similar to the that described hereinabove for reducing heat loss through end walls 24 and 26 of container 20. Like the end walls, heat loss through dam 200 may be reduced by varying the thickness of section 204 to facilitate consistent temperature properties during electrophoresis runs, regardless of the number of gels being run.

Referring now to FIG. 10B, an arrangement is described whereby a user can run only two gels in container 20 simultaneously. Buffer core assembly 60c having first and second gel cassettes 80a and 80b is inserted into and secured within chamber 30c of container 20 as described hereinabove. Then, buffer core assembly 160 having dam 200 is inserted into chamber 30b, as shown in FIG. 10B.

In the arrangement of FIG. 10B, U-shaped strip 211 of dam 200 is configured to block flow through aperture 113 of second bulkhead lob of chamber 30b. Therefore, U-shaped strip 211 helps ensure that the second buffer in lower buffer chamber 140 does not flow into chambers 30a and 30b.

A first buffer (not shown) is poured into upper buffer chamber 130c, and a proportional amount of a second buffer (not shown) is poured into lower buffer chamber 140. For example, when 200 mL of first buffer is poured into upper buffer chamber 130c, and 200 mL of second buffer is poured into lower buffer chamber 140, then 100 mL of first buffer is devoted as a heat sink for each of the inner surfaces of cassettes 80a and 80b, and 100 mL of second buffer is devoted as a heat sink for each of the outer surfaces of cassettes 80a and 80b. Accordingly, the temperature on the outer and inner surfaces 81a and 81b of cassette 80a will be approximately the same, assuming the specific heat of the buffers are substantially identical.

Referring now to FIG. 10C., an arrangement is described whereby a user can run only three gels in container 20 simultaneously. Buffer core assembly 60a having first and second gel cassettes 80a and 80b is inserted into and secured within chamber 30a of container 20, as described hereinabove. Then, buffer core assembly 160 having first cassette 80a and dam 200 is inserted into chamber 30b, as shown in FIG. 10C.

In the arrangement shown in FIG. 10C, U-shaped strip 211 of dam 200 is configured to block flow through aperture 113 of second bulkhead 110b of chamber 30b. Therefore, U-shaped strip 211 helps ensure that the second buffer in lower buffer chamber 140 does not flow into chamber 30c.

A first buffer (not shown) is poured into upper buffer chamber 130a. Then, one-half of the first buffer volume poured into chamber 130a is poured into chamber 230b. A proportional amount of a second buffer (not shown) then is poured into one of the regions of lower buffer chamber 140 shown in FIG. 10C. For example, when 200 mL of first buffer is poured into upper buffer chamber 130a, then 100 mL of first buffer is poured into upper buffer chamber 230b, and 300 mL of second buffer is poured into common lower buffer chamber 140. In effect, both outer and inner surfaces 81a and 81b of the three cassettes being run will have 100 mL of second and first buffer, respectively, devoted as a heat sink to the outer and inner cassette surfaces. Accordingly, the temperature on the outer and inner surfaces 81a and 81b of each cassette will be the same, assuming the specific heat of the buffers are substantially identical.

As will be apparent to one skilled in the art, four or five gels also may be run simultaneously by further varying the location of dam 200 within container 20 and varying the number of cassettes employed. Moreover, it will be apparent to one skilled in the art that greater than six gels may be run simultaneously by providing additional chambers 30. Advantageously, dam 200 can block flow to regions of container 20 so that any number of gels can be run simultaneously. The user simply needs to adjust the volume of first and second buffers in a proportional manner, as illustratively described hereinabove, to maintain proper thermal management in the system.

All patents and publications cited in this specification are herein incorporated by reference as if each had specifically and individually been incorporated by reference herein. Although the foregoing invention has been described in some detail by way of illustration and example, it will be readily apparent to those of ordinary skill in the art, in light of the teachings herein, that certain changes and modifications may be made thereto without departing from the spirit or scope of the appended claims, which, along with their full range of equivalents, alone define the scope of invention.

1-31. (canceled)

32. Apparatus suitable for conducting multiple concurrent electrophoresis experiments, the apparatus comprising:
a container having a plurality of chambers;
a removable lid configured to cover the container; and
at least one substantially noncompliant wedge-shaped member disposed in each of the chambers,
wherein each of the chambers are configured to receive a buffer core assembly suitable for effecting at least one electrophoresis experiment.

33. The apparatus of claim 32, wherein each chamber comprises a first bulkhead and a second bulkhead, wherein the first bulkhead and the second bulkhead are configured to provide an inward pressure upon a respective buffer core assembly.

34. The apparatus of claim 33, wherein the first bulkhead and the second bulkhead both comprise a laterally protruding upper region.

35. The apparatus of claim 34, wherein at least one of the substantially noncompliant wedge-shaped members is disposed on a lower region of the first bulkhead, and at least one of the substantially noncompliant wedge-shaped members is disposed on a lower region of the second bulkhead, wherein the substantially noncompliant wedge-shaped members of the first bulkhead and the second bulkhead are configured to apply inward pressures upon a buffer core assembly.

36. The apparatus of claim 32, wherein a lower portion of the container is configured to form a common lower buffer chamber.

37. The apparatus of claim 36, wherein the common lower buffer chamber is configured to receive a second buffer, and further is configured such that the second buffer is capable of being placed in fluid communication with outer surfaces of a plurality of gel cassettes when the gel cassettes are disposed in the container.

38. The apparatus of claim 36, wherein a portion of the common lower buffer chamber is formed as a space between a first chamber of the container and an end wall of the container.

39. The apparatus of claim 36, wherein a portion of the common lower buffer chamber is configured to be formed as a space between a first buffer core assembly and a second buffer core assembly, the first and second buffer core assemblies configured to be disposed in first and second chambers of the container, respectively.

40. The apparatus of claim 32, wherein the container is configured to enable passive thermal management techniques to be used to control temperature during multiple concurrent electrophoresis experiments.

41. The apparatus of claim 40, wherein the passive thermal management techniques comprise using first and second buffers as heat sinks during the multiple concurrent electrophoresis experiments.

42. The apparatus of claim 40, wherein the container is configured such that a proportional volume of first and second buffer may be added to an upper buffer chamber and a lower buffer chamber, respectively.

43. The apparatus of claim 32, further comprising a dam configured to block flow of a second buffer to selected regions of the container.

44. The apparatus of claim 43, wherein the dam is configured to be coupled to a buffer core body of a buffer core assembly.

45-65. (canceled)

66. A method for conducting concurrent electrophoresis experiments in a plurality of gels, the method comprising:
a) inserting a first buffer core assembly having a buffer core body and first and second cassettes in contact with front and back sides of the buffer core body into a first chamber of a container;
b) pouring a first buffer into an upper buffer chamber formed as a space between the buffer core body and inner surfaces of the first and second cassettes, the first buffer being placed in fluid communication with electrophoresis gels disposed in the first and second cassettes;
c) optionally repeating steps a) and b) for one or more additional buffer cores;
d) pouring a second buffer into a common lower buffer chamber, whereby the second buffer is placed in communication with outer surfaces of the first and second cassettes, and further in communication with the electrophoresis gels disposed in the first and second cassettes, wherein a proportional volume of first and second buffer are poured into the upper buffer chamber and the common lower buffer chamber, respectively; and
e) generating an electric field on the electrophoresis gels to effect molecular separation of electrophoresis samples.

67. The method of claim 66, wherein inserting the first buffer core assembly into the first chamber comprises inserting the first buffer core assembly between a first bulkhead and a second bulkhead disposed in the container.

68. The method of claim 67, further comprising allowing the second buffer to flow through apertures in the first and second bulkheads.

69. The method of claim 67, further comprising securing the first buffer core assembly in the first chamber using at least one wedge-shaped member disposed on a lower region of the first bulkhead, and at least one wedge-shaped member disposed on a lower region of the second bulkhead.

70. The method of claim 66, further comprising:
providing a first male conductor and a second male conductor coupled to the buffer core body; and
causing the first and second male conductors to engage first and second sockets coupled to the container when the first buffer core assembly is securely disposed in the first chamber.

71. The method of claim 66, further comprising effecting isolation between the upper buffer chamber and the common lower buffer chamber using a resilient sealing means disposed between the first cassette and a back side of the buffer core body, and between the second cassette and a front side of the buffer core body.

72. The method of claim 66, further comprising:
providing a dam coupled to a back side of the buffer core body; and
causing the dam to block flow of the second buffer to selected regions of the container.

73. The method of claim 72, wherein between 30% and 80% of the volume of the first buffer are poured into the upper buffer chamber in the presence versus absence of the dam.

74. The method of claim 66, further comprising using passive thermal management techniques to control temperature of the electrophoresis gels.

75. The method of claim 74, further comprising using the first and second buffers as heat sinks during electrophoresis.

76. The method of claim 75, wherein between 40% and 70% of the volume of the first buffer are poured into the upper buffer chamber in the presence versus absence of the dam.

77. The method of claim 75, wherein temperature is controlled such that temperature of the upper buffer and temperature of the lower buffer are within 10 degrees Celsius of each other at the end of the electrophoretic separation of electrophoresis samples.

78. The method of claim 75, wherein temperature is controlled such that a temperature of the first buffer within a first buffer core and a temperature of a first buffer within a second buffer core located within the container, are within 10 degrees Celsius of each other at the end of the electrophoretic separation of electrophoresis samples.

79. The method of claim 75, wherein current and temperature are controlled between a plurality of buffer cores within the container, such that a dye front is within 5 millimeters for each gel in the container at the end of the electrophoretic separation of electrophoresis samples.

80. The method of claim 75, wherein current and temperature are controlled between a plurality of buffer cores within the container, such that a dye front is within 10% of the total length of a gel for each gel in the container at the end of the electrophoretic separation of electrophoresis samples.

81. The method of claim 66, wherein the method is performed without the use of moving parts.

82. The apparatus of claim 32, wherein the chamber and the buffer core do not comprise moving parts.
